(19) United States
(12) Patent Application Publication
(10) Pub. No.: US 2006/0199443 A1
(43) Pub. Date: Sep. 7, 2006

(54) Printed circuit board and display device using the same

(75) Inventor: Wen Kai Lo, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,316

(22) Filed: Dec. 23, 2005

(30) Foreign Application Priority Data
Dec. 30, 2004 (CN) 200420103592.1

(51) Int. Cl. H01R 4/48

(52) U.S. Cl. 439/835

(57) ABSTRACT

A display device (20) includes a display panel (25) and a rigid-flexible printed circuit board (2) electrically connected to the display panel. The rigid-flexible printed circuit board has the characteristics of both a rigid and a flexible printed circuit board, thereby reducing the size of the rigid-flexible printed circuit board and the amount of connectors required. Additionally, the cost of the rigid-flexible printed circuit board is less than that of a conventional printed circuit board.

### FIELD OF THE INVENTION

The present invention relates to a rigid-flexible printed circuit board and a display device using the same.

### GENERAL BACKGROUND

As shown in FIG. 3, a typical display device 4 includes a controlling circuit board 40 and a display main body 41. The display main body 41 includes a plurality of elements, such as a control panel, a liquid crystal panel, and a light source. The controlling circuit board 40 includes a first flexible printed circuit board 402, a second flexible printed circuit board 404, and a third flexible printed circuit board 406.

The first flexible printed circuit board 402 connects with the control panel, the second flexible printed circuit board 404 connects with the light source, and the third flexible printed circuit board 406 connects with the liquid crystal panel. The third flexible printed circuit board 406 integrates the data signals from the light source and the control panel.

However, the first flexible printed circuit board 402, the second flexible printed circuit board 404, and the third flexible printed circuit board 406 are joined together to form the controlling circuit board 40 in a complicated process of jointing or fastening with many connectors. Additionally, the controlling circuit board 40 is connected with the display main body 41 by many connectors. Thus, the cost of the assembly and the time needed for assembly are unduly excessive.

What is needed, therefore, is a printed circuit board and a display device that overcome the above-described deficiencies.

### SUMMARY

In a preferred embodiment, a rigid-flexible printed circuit board includes a flexible printed circuit board and a main board connected together.

In another preferred embodiment, a display device includes a display panel and a rigid-flexible printed circuit board electrically connected to the display panel.

The rigid-flexible printed circuit board has the characteristics of both a rigid and a flexible printed circuit board, which reduces the size of the rigid-flexible printed circuit board, the amount of connectors required, and the cost of manufacture.

Other advantages and novel features will become more apparent from the following detailed description when taken in conjunction with the accompanying drawings.

### BRIEF DESCRIPTION OF THE DRAWINGS

FIG. 1 is a schematic, top view of a printed circuit board according to a first embodiment of the present invention.

FIG. 2 is a schematic, cutaway, top view of a display device employing the printed circuit board of FIG. 1.

FIG. 3 is a schematic, top, partially cross-sectional view of a display device employing a conventional circuit board.

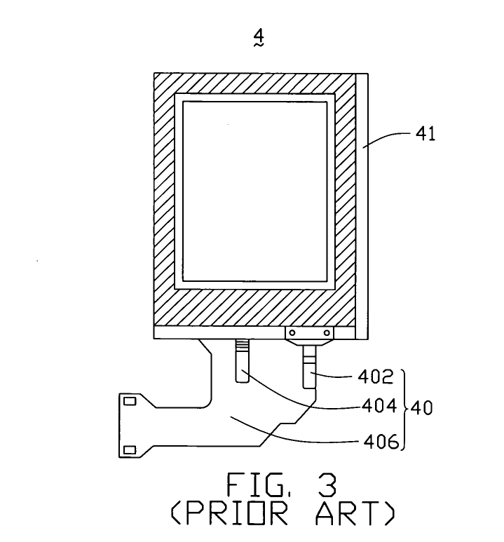

### DETAILED DESCRIPTION OF PREFERRED EMBODIMENTS

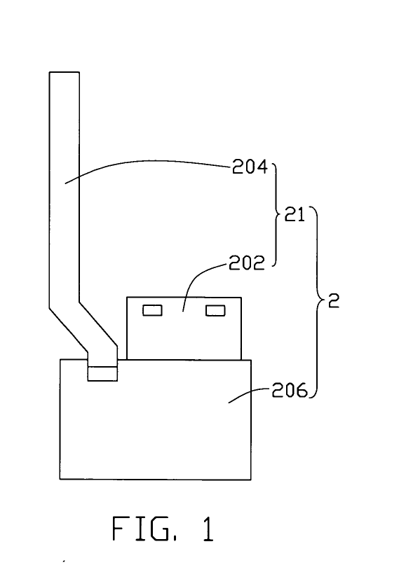

FIG. 1 is a schematic, top view of a printed circuit board according to a first embodiment of the present invention. The printed circuit board 2 includes a data transmission element 21 and a main board 206. The data transmission element 21 includes a first flexible printed circuit board 202 and a second flexible printed circuit board 204.

The printed circuit board 2 is a rigid-flexible printed circuit board. The main board 206 is a signal generation element having a characteristic of a rigid printed circuit board. The first flexible printed circuit board 202 and the second flexible printed circuit board 204 transmit data signals. The first flexible printed circuit board 202 and the second flexible printed circuit board 204 extend from the main board 206.

The first flexible printed circuit board 202 and the second flexible printed circuit board 204 are partially embedded in the main board 206, and therefore the printed circuit board 2 has the characteristics of both a rigid and a flexible printed circuit board. Additionally, the cost of the printed circuit board 2 is less than that of a conventional printed circuit board.

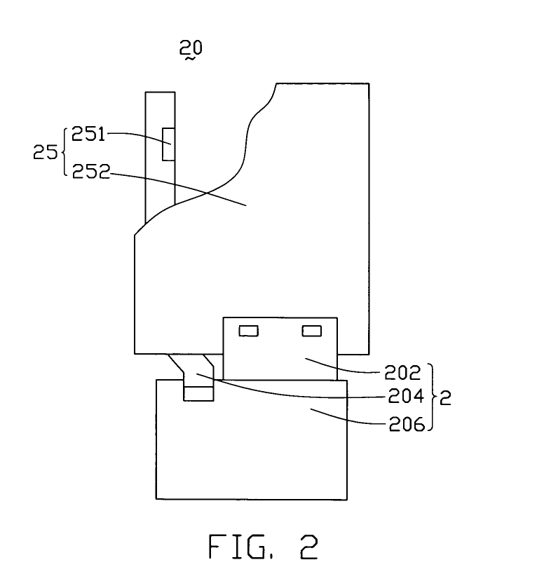

FIG. 2 is a schematic, cutaway, top view of a display device employing the printed circuit board of FIG. 1. The display device 20 includes a display main body 25 and a rigid-flexible printed circuit board 2. The printed circuit board 2 includes a first flexible printed circuit board 202, a second flexible printed circuit board 204, and a main board 206. The display main body 25 includes a light source module 251 and a display panel 252. The first flexible printed circuit board 202 is connected with the display panel 252, and the second flexible printed circuit board 204 is connected with the light source module 251. The main board 206 integrates data signals originating from the light source module 251 and the display panel 252.

In summary, the first flexible printed circuit board 202 and the second flexible printed circuit board 204 are partially embedded in the main board 206, and therefore the printed circuit board 2 has the characteristics of both a rigid and a flexible printed circuit board. The connectors used in a typical printed circuit board may be omitted, and therefore the cost and the assembly time of the display device 20 are less than those of a conventional display device.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rigid-flexible printed circuit board, comprising a flexible printed circuit board and a main board connected together.

2. The rigid-flexible printed circuit board as claimed in claim 1, wherein the main board is a rigid printed circuit board.

3. A display device, comprising:
a display panel; and
a rigid-flexible printed circuit board electrically connected to the display panel.

4. The display device as claimed in claim 3, wherein the rigid-flexible printed circuit board includes a flexible printed circuit board connected with a main board.

5. The display device as claimed in claim 4, wherein the main board is a rigid printed circuit board.

6. The display device as claimed in claim 4, further comprising a light source module electrically connected to the flexible printed circuit board.
